(19) United States
(12) Patent Application Publication
(10) Pub. No.: US 2023/0282135 A1
(43) Pub. Date: Sep. 7, 2023

(54) Method and Device for Testing Child Presence Detection Systems

(71) Applicant: MESSRING GmbH, Gilching (DE)

(72) Inventors: Igor Doric, Ingolstadt (DE); Martin Simon, Karlshuld (DE); Thomas Holdgrün, Ingolstadt (DE)

(21) Appl. No.: 18/115,393

(22) Filed: Feb. 28, 2023

(30) Foreign Application Priority Data
Mar. 1, 2022 (DE) 10 2022 104 862.4

(51) Int. Cl. G09B 23/32

(52) U.S. Cl. CPC G09B 23/32

(57) ABSTRACT

The invention relates to a dummy object for functional testing of child presence detection (CPD) systems, including a torso having a chest region, an abdominal region, and a back region, further including an upper body part movable relative to the torso for imitating a breathing movement. The upper body part forms at least a part of a chest-abdomen contour of the dummy object to be detected by the CPD system, and includes an actuator that is arranged to deflect the upper body part from a basic position into a deflected position. The dummy object includes at least one elastic reset element that is arranged to return the upper body part from the deflected position to the basic position.

### CROSS-REFERENCE TO RELATED APPLICATION

This application claims priority to German Patent Application No. 10 2022 104 862.4 filed Mar. 1, 2022, the disclosure of which is hereby incorporated by reference in its entirety.

### BACKGROUND OF THE INVENTION

### Field of the Invention

The present invention relates to a dummy object for testing child presence detection systems (CPD systems) as described herein.

### Description of Related Art

Generic dummy objects are used in the development and testing of CPD systems in motor vehicles. CPD systems, in other words, systems for child presence detection, are intended to ensure that children are no longer left alone in a vehicle, neither intentionally nor unintentionally. The development of such systems takes into account the fact that a not inconsiderable number of children still die every year because they are left alone in a parked car. In addition, CPD systems will be taken into account in Euro NCAP's star ratings from 2023. Vehicle manufacturers are thus required to provide or improve CPD systems in their vehicles. Real humans cannot be used either during testing at the development stage or during the testing and evaluation of such systems by independent test centers. On the one hand, standardization requirements make the use of dummies unavoidable, and on the other hand, the scope of application of such systems in vehicles is primarily for children between 0 and 6 years of age. Among other things, CPD systems must be able to reliably detect the presence of a child during a so-called parking situation. Various systems are used for this purpose, such as sensors that detect possible movements of the child. Such systems reach their limits when the object to be detected does not move or hardly moves at all. One such scenario is a sleeping newborn baby, which naturally does not move at all. Such systems are therefore designed to detect the movement of the upper body, which is caused by breathing. Consequently, to test such systems, dummy objects are needed that are able to reproduce the movement of breathing in children between 0 and 6 years of age.

A dummy object is known, for example, from EP113697061, which is incorporated by reference herein. Therein, a human dummy is described as a training device for training in first aid measures. The dummy has a torso including a back region as well as a chest region and an abdominal region. Moreover, there are described front panels that mimic the contour of the chest and abdominal regions and that use an actuator to imitate movement of the chest and abdominal regions.

Other dummy objects are known from the prior art, in which the chest and/or abdomen area may be moved by means of an actuator, as described, for example, in documents KR102330700B1, EP3701513A1 and U.S. Pat. No. 4,601,665A.

Although the use of CPD systems in vehicles is not new, there have been no explicit specifications which manufacturers could adhere to during development and according to which corresponding CPD systems could be tested for evaluation. Accordingly, the development of appropriate test equipment is still in its infancy, which is why simple children's or baby dummies have been used to date. After the provision of test requirements and concrete test scenarios by Euro NCAP, however, it has become apparent that adequate testing of CPD systems is not possible with simple puppets or dummy objects that have not been developed for use as test equipment for CPD systems.

One reason for this is that the detection of children in a vehicle is also based on the detection of movements using radar sensors. A difficult scenario for the sensor is therefore a parking situation where the child is asleep in his or her child seat and therefore may not move. The only detectable movement in such a case is the movement of the chest and abdomen caused by breathing. The ability of a dummy object to mimic the movement of the chest and abdomen caused by respiration in children between 0 and 6 years of age is therefore essential for testing CPD systems.

Dummy objects are known from the prior art, for example from EP113697061, which can mimic certain vital functions such as breathing as training for medical personnel.

A disadvantage of such dummy objects is that they are very complex and a considerable part of the required actuator technology is located within the dummy object itself. An important requirement for dummy objects in the testing of CPD systems is that, on the one hand, as few electrical components as possible, or preferably none at all, should be installed within the test equipment in order to rule out any possible interference with the sensor systems. On the other hand, metallic components should also be avoided in order to counteract a possible falsification of the radar signature of the test object compared to a real child.

From the prior art, a dummy object is further known that simulates the movement of an upper body by breathing and heartbeat for testing a radar sensor. The simulation of the motion is performed by means of inflatable air sacs, which are fed by a pneumatic system and are arranged inside the upper body. Their expansion is transmitted to the exterior of the torso via a gel bag, allowing fine movements to be simulated.

A disadvantage of this arrangement, however, is that parameterization of the desired respiratory movement in terms of respiratory frequency, maximum expansion of the chest and abdomen, and the interaction of abdominal breathing and chest breathing is very complex. However, in the context of a test or inspection operation, it is necessary to be able to operate a dummy object in different breathing modes in a short time and to use dummy objects of different sizes without having to carry out time-consuming parameterization of the breathing movement in between.

### SUMMARY OF THE INVENTION

It is therefore the object of the present invention to provide a dummy object for testing CPD systems, which imitates the breathing movement of the chest and abdomen of a human being and, in particular, of children and which may be used flexibly with low complexity.

The object is solved by the features as described herein. Accordingly, a solution to the object according to the invention is obtained if the dummy object has at least one elastic reset element that is set up to return the upper body part from a deflected position to a basic position.

Advantageous embodiments of the present invention are described herein.

According to an advantageous embodiment of the present invention, the elastic reset element is an expander, wherein the dummy object preferably comprises at least two expanders and particularly advantageously four expanders. However, it is also conceivable that the reset element is a spring, for example a helical spring. The expander is preferably in the form of a rope or band and is fastened in the back region of the torso. The fastening may be accomplished, for example, by providing the two ends of the expander with a knot that may be fixed in a first recess in the back region. The expander may be guided and held in position via a second recess that extends, for example, from the abdominal region and/or from the chest region to the back region. The expander is configured to return the upper body part from the deflected position to the basic position. The expander thus performs a task that is conventionally carried out by an actuator. This has the advantage that the complexity of the actuator may be reduced.

According to another advantageous embodiment of the present invention, the dummy object comprises two legs and the torso comprises a cavity, wherein the cavity may be at least partially enclosed by the upper body part. The torso further comprises a through-hole, preferably arranged between the legs and forming an access to the cavity. Alternatively, the through-hole may be provided in the back portion. The actuator, which is adapted to deflect the torso member from a basic position to a deflected position, is preferably disposed in the cavity and is coupled to a supply system through the through-hole. However, the actuator may alternatively be arranged outside the cavity, in which case the through-hole may be omitted.

According to a particularly advantageous embodiment of the present invention, the actuator comprises at least one inflatable balloon and preferably at least two inflatable balloons. The at least one inflatable balloon is connected to the supply system via a compressed air hose, wherein the supply system is a pneumatic system. The at least one inflatable balloon is arranged to increase its volume by supplying compressed air and to decrease the volume again by releasing the compressed air. If the volume of the at least one balloon exceeds the volume of the cavity, in which the balloon is arranged, by supplying compressed air, the balloon sets the upper body part in motion relative to the torso. It is also conceivable that two balloons are arranged in the cavity in such a way that one balloon sets the abdominal region of the upper body part in motion by its expansion and the other balloon sets the chest region of the upper body part in motion by its expansion.

According to another advantageous embodiment of the present invention, the pneumatic system comprises a valve unit and a control unit arranged to supply and release air to and from the inflatable balloon in a controlled manner. For example, the time within which the balloon is inflated to a certain size may be controlled. Preferably, the valve unit and control unit form a common unit separate from the dummy object and are connected to the dummy object via at least one compressed air hose. This results in the advantage that the valve unit and control unit may be positioned in the trunk or outside the vehicle. As a result, no additional electronics are located in the passenger compartment during the test operation, and metallic components that may interfere during the test operation are also reduced to a minimum or may even be avoided altogether.

According to a further advantageous embodiment of the present invention, the pneumatic system is configured to simulate the movement of the human chest and abdomen during inhalation by controlled air supply and the accompanying deflection of the upper body part from the basic position to the deflected position. The speed with which the balloon is filled with air may be used to emulate the speed of the breathing movement, and the frequency with which the balloon is filled with air may be used to emulate the breathing frequency.

According to a further advantageous embodiment of the present invention, the pneumatic system is arranged to reset the upper body part from a deflected position to a basic position by the controlled release of air from the balloon in conjunction with the reset element, thereby emulating the movement of the human chest and abdominal region during exhalation.

It is also conceivable that at least two expanders are used to further model the breathing movement, wherein at least one expander is placed in the abdominal region and at least one other expander is placed in the chest region, and wherein the expanders may have different elasticity, whereby the movement of the upper body part in the chest region differs from the movement of the upper body part in the abdominal region during both inhalation and exhalation. Alternatively, different numbers of expanders may be provided in the abdominal region and the chest region to represent different movements of the abdominal region and the chest region.

According to an advantageous embodiment of the present invention, the valve unit is actuated by means of pulse width modulation, wherein the valve unit preferably comprises fast switching valves.

According to a particularly advantageous embodiment of the present invention, the upper body part comprises at least one stroke limiting element, wherein the stroke limiting element is arranged to limit the movement of the upper body part relative to the torso to a maximum stroke. The stroke limiting element is arranged centrally between the chest region and the abdominal region of the upper body part. Alternatively, the stroke limiting element may also be arranged in the chest region of the upper body part or in the abdominal region of the upper body part. The stroke limiting element may be arranged to connect the upper body part to the torso.

According to a particularly advantageous embodiment of the present invention, the upper body part comprises at least two stroke limiting elements, preferably at least one first stroke limiting element being fixed in the abdominal region and at least one second stroke limiting element being fixed in the chest region of the torso, wherein the stroke of the upper body part in the abdominal region may be different from the stroke of the upper body part in the chest region.

According to a particularly advantageous embodiment of the present invention, the stroke limiting element is a Hook-and-loop tape, wherein the hook-and-loop tape is adapted to be manually fastened and adjusted. Preferably, the hook-and-loop tape is attached to the upper body part and has two ends that may be connected to each other in the manner of a hook-and-loop fastener. Preferably, these two ends are passed around the torso of the dummy object and fastened to each other in the back region. However, it is also conceivable that the two ends of the hook-and-loop tape are fastened via a corresponding hook-and-loop element that is firmly connected to the torso in the back region of the torso. Alternatively, for example, each of the two hook-and-loop tapes may be made in two parts. A particular advantage of such a stroke-limiting element is that the maximum breathing movement of the upper body part may be adjusted manually, quickly and flexibly to the respective requirements and test conditions without having to carry out a time-consuming calibration of the control system. The special coupling of dummy object and control and valve unit allows the use of the system consisting of control and valve unit for different dummy objects without having to adapt it to the new conditions.

According to a particularly advantageous embodiment of the present invention, the upper body part is attached to the torso with four expanders and two hook-and-loop tapes. Once the expanders and hook-and-loop tapes are removed, the upper body part may be removed manually. It is also conceivable that the torso has a third material recess that corresponds to the contour of the upper body part, and that the upper body part is inserted into the third material recess in its basic position in such a way that the upper body part fills the third material recess in the manner of a missing puzzle piece.

According to an advantageous embodiment of the present invention, the upper body part is embodied in such a way that materials having different properties with respect to detectability by radar may be applied to the upper body part. In order to be able to test the CPD system under different conditions, it is useful to be able to change the radar signature of the dummy object. For this purpose, the material on the upper body part may be exchanged quickly and flexibly to ensure a smooth test operation.

According to another advantageous embodiment of the present invention, the upper body part is made in two parts and the two parts of the upper body part are independently movable. Preferably, the division is made into an abdominal region and a chest region, wherein the abdominal region and the chest region of the upper body part are hingedly connected to each other. However, it is also conceivable that the abdominal region and the chest region of the upper body part are designed as two separate components. The advantage of a two-part configuration of the upper body part is that the movement of the chest region and the movement of the abdominal region during breathing may be mapped independently of each other.

According to a further advantageous embodiment of the present invention, a pressure silencer, a compressed air filter and a mechanical pressure limiter are associated with the inflatable balloon, wherein the pressure in the balloon is continuously monitored and wherein the pressure in the balloon should not exceed 2 bar, preferably 1.5 bar and further preferably 1.3 bar.

According to another advantageous embodiment of the present invention, the dummy object comprises four limbs representing two arms and two legs and comprises a head with two eyes. Preferably, the limbs and the head are movably connected to the torso and the eyes may be opened and closed. Conceivably, the torso comprises a mechanism adapted to move the limbs and the head relative to the torso and to open and close the eyes by means of the actuator that also moves the upper body part relative to the torso.

According to a further advantageous embodiment of the present invention, the dummy object reproduces the external appearance of a human, preferably that of a child and further preferably the external appearance of a 6-year-old or younger child.

According to a further embodiment of the present invention, the actuator may comprise at least one rotationally driven eccentric by means of which the upper body part may be deflected from the basic position into the deflected position. The eccentric may be driven by a motor. The motor is preferably an electric motor, in particular a servomotor. However, it is also conceivable to configure the motor as a pneumatic motor, for example. Advantageously, a separate eccentric drive may be arranged in the chest region and in the abdominal region of the dummy object in each case, so that the abdominal region and the chest region of the upper body part may be deflected differently. In the simplest case, the eccentric is configured as a simple, eccentrically rotatable turntable with a preferably circular contour. The turntable is preferably in direct and driving contact with the upper body part, so that a rotary movement of the eccentric or the turntable is translated into a lifting or deflecting movement of the upper body part. Two or more turntables may also be provided per eccentric drive, for example a first turntable on the left side and a second turntable on the right side of the upper body part. This ensures that the upper body part does not tilt sideways when the breathing movement is imitated.

It is also conceivable that the outer contour of the turntable does not correspond to a circular shape but to any outer contour, by which a special movement pattern of the upper body part may be achieved during the adjustment of the breathing movement. It is particularly advantageous if the turntables are designed to be interchangeable, so that different movement patterns may be set by exchanging the turntables. The maximum stroke of the upper body part preferably results from the contour of the turntables, wherein the breathing frequency may be adjusted on the basis of the rotational speed of the motor. Especially if the motor is configured as a servo motor, different movement patterns and maximum strokes—without having to change the turntable—may also be achieved by alternating forward and backward movements of the motor, by different or varying rotation speeds, as well as by different rotation angles.

According to a conceivable alternative solution to the object or alternative embodiment of the present invention, the actuator has an electric motor, which is preferably configured as a servomotor. In this embodiment, the actuator is arranged to deflect the upper body part from the basic position to a deflected position and to reset it from the deflected position to the basic position. In this embodiment, the actuator may perform the task of the reset element, which is not required in this embodiment. An eccentric may also be used in this embodiment as explained above.

The present invention also provides a method for adjusting the maximum stroke of the upper body part during the breathing movement of the dummy object. To this end, at least one spacer element is used to set up the stroke limiting element, wherein the size of the spacer element corresponds in at least one spatial dimension to the stroke to be set. The stroke limiting element is initially not fixed, so that the spacer element may be fitted between the torso and the upper body part. Subsequently, the stroke limiting element is fixed so that the maximum stroke of the breathing movement is set after removing the at least one spacer element. For easier handling, alternatively firstly, the elastic restraining elements for setting the maximum stroke may be removed and reattached after setting the maximum stroke. For accurate adjustment of the stroke, it is convenient to use four spacer elements, one on the left and one on the right in the abdominal region and in the chest region, respectively. Once all the spacer elements are installed, the hook-and-loop tapes in the back region are fixed to each other at their ends, in the manner of a hook-and-loop fastener. If a different maximum stroke is to be set for the chest region and the abdominal region, spacer elements with different heights may be used. Then, it may be convenient to first adjust the range of the larger maximum stroke and when the corresponding hook-and-loop tape is fixed, proceed to adjust the range of the smaller maximum stroke.

### BRIEF DESCRIPTION OF THE DRAWINGS

An embodiment of the present invention will be explained in more detail below with reference to the following drawings.

In the figures:

FIG. 1: is a schematic representation of an embodiment of the present invention,

FIG. 2: is a schematic representation of the back region of the embodiment of the present invention according to FIG. 1,

FIG. 3a: is a sectional view of the torso and upper body part in the deflected state,

FIG. 3b: is a schematic representation of a further embodiment of the present invention,

FIG. 4: is a schematic representation of an embodiment of the present invention according to FIG. 1 in the deflected state, and

FIG. 5: is a schematic representation explaining the method of setting the maximum stroke according to the present invention.

### DESCRIPTION OF THE INVENTION

In the following embodiments, identical parts are indicated by identical reference signs. If a figure contains reference signs that are not dealt with in detail in the associated figure description, reference is made to preceding or subsequent figure descriptions. As used herein, the singular form of “a”, “an”, and “the” include plural referents unless the context clearly states otherwise.

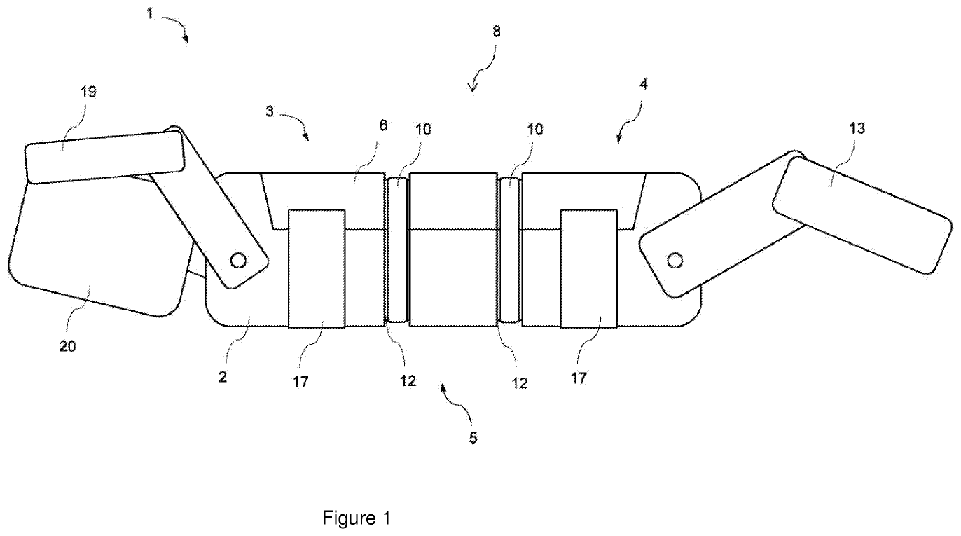

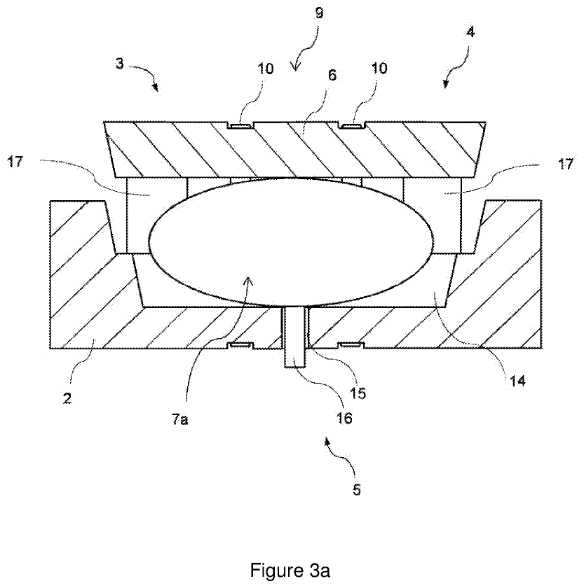

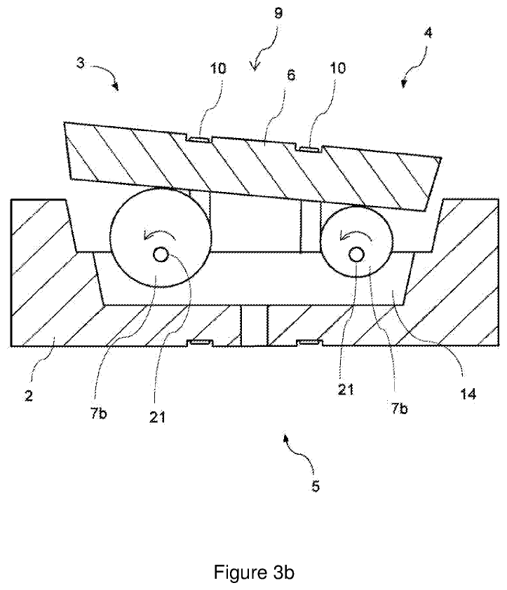

FIG. 1 shows the schematic structure of a dummy object 1 according to one embodiment of the present invention comprises a torso 2, which has a chest region 3, an abdominal region 4 and a back region 5, and comprises an upper body part 6, which is movable relative to the torso 2 to simulate a breathing movement, wherein the upper body part 6 forms at least a part of a chest-abdomen contour of the dummy object 1 to be detected by a CPD system, and with an actuator 7 that is arranged to deflect the upper body part 6 from a basic position 8 into a deflected position 9. In this embodiment, the actuator 7 is arranged in a cavity 14 shown in FIG. 3a. The dummy object 1 further comprises two elastic reset elements 10, which are arranged to return the upper body part 6 from the deflected position 9 to the basic position 8.

The upper body part 6 is shown in the basic position 8 in FIG. 1 and is connected to the torso 2 by means of two reset elements 10, which in this case are configured as expanders 10, and by means of two stroke limiting elements 17, which are designed as hook-and-loop tapes. The upper body part 6 also has a recess, which continues the second recess 12 in the torso 2 and with which the expander 10 is held in position. To realistically replicate the exterior of a child, the dummy object comprises two legs 13 and two arms 19 and a head 20.

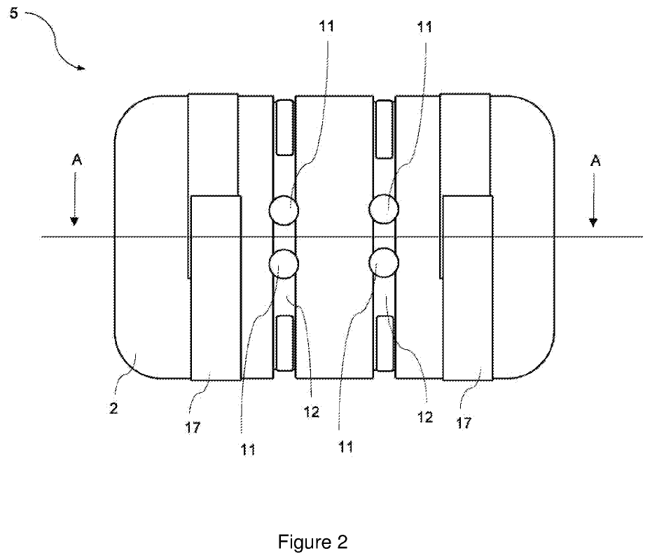

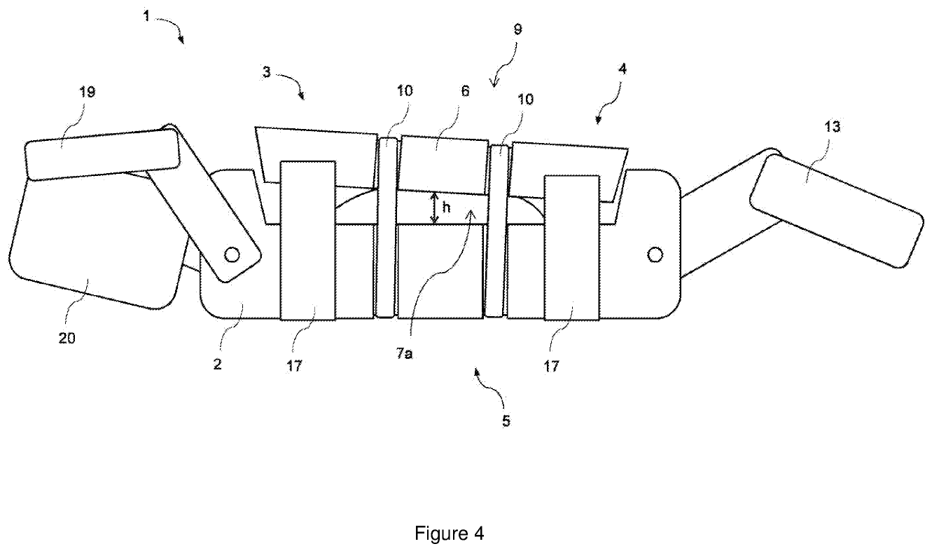

FIG. 2 shows the back region 5 of the embodiment of the present invention shown in FIG. 1 without the arms 19, the legs 13 and the head 20. The second recess 12 of the torso 2 is also made around the entire back region 5. In the central area of the back region 5, a first recess 11 of circular design is provided within the second recess 12, in which the ends of the expanders 10 may be clamped and thus fixed by means of knots. The configuration of the knot is not shown in FIG. 2. The hook-and-loop tape is firmly connected to the upper body part 6, the two ends of the hook-and-loop tape being looped around the torso 2 and fastened to each other in the back region in the manner of a hook-and-loop fastener. In the embodiment shown in FIG. 2, two hook-and-loop tapes are provided, one hook-and-loop tape being arranged in the chest region 3 and one hook-and-loop tape being arranged in the abdominal region 4, and each of the hook-and-loop tapes being set up to adjust the maximum stroke h of the upper body part 6 for its respective regions 3, 4. FIG. 4 shows the upper body part 6 in deflected position 9, wherein the adjusted stroke h in the chest region 3 is greater than the adjusted stroke h in the abdominal region 4.

FIG. 3a shows a schematic sectional view A-A of the torso 2 with the upper body part 6 being in deflected position 9. The cavity 14 is enclosed by the upper body part 6 in the basic position 8. The actuator 7, which in the embodiment shown comprises a balloon 16, is coupled to the supply system via a through-hole 15 by means of a compressed air hose 16. When compressed air is applied to the balloon, the balloon expands. If the volume of the balloon exceeds the volume of the cavity 14, the upper body part 6 is moved out of the basic position 8. The upper body part 6 reaches the deflected position 9 when the maximum stroke h allowed by the hook-and-loop tape 17 is reached. As shown in FIG. 4, the maximum stroke h of the chest region 3 need not coincide with the maximum stroke h of the abdomen region 4.

FIG. 3b shows an alternative embodiment of the present invention. The actuator 7 comprises two eccentric or rotating disks 7b in the chest region 3, two eccentric or rotating disks 7b in the abdominal region, and one motor for each pair of rotating disks. The two rotating disks 7b arranged on the right and left in the chest region 3 and the two rotating disks 7b likewise arranged on the right and left in the abdominal region 4 are arranged in such a way that the rotating disks 7b arranged in each case at the rear in the illustration are covered by the two front rotating disks 7b. The associated motor is arranged in each case between two turntables 7b and is therefore also not visible in the figure. The axis of rotation of a pair of turntables corresponds in each case to the motor axis 21. The motor may be an electric motor or, alternatively, may be configured as a geared pneumatic motor, for example. The deflection of the upper body part 6 from the basic position 8 into the deflected position 9 is effected by the rotation of the rotary discs 7b about their off-center axis of rotation 21. The movement of the upper body part 6 from the deflected position 9 into the basic position 8 is effected by the upper body part 6, supported by the expanders 10, further following the contour of the rotary discs 7b. The shape of the turntables 7b also determines the maximum stroke h of the upper body part 6 in the embodiment shown, and the breathing frequency is set accordingly via the rotational speed of the motors 21. As shown above, different maximum strokes and/or movement patterns may also be achieved by using a servomotor and controlling it accordingly.

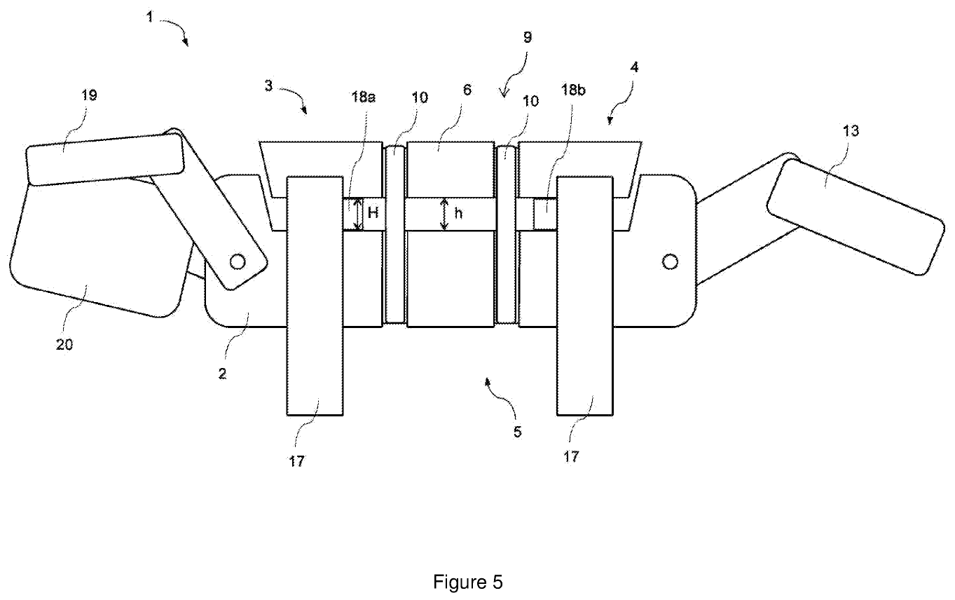

FIG. 5 shows the method according to the invention for adjusting the maximum stroke h in the embodiment of FIGS. 1, 2, 3a and 4. For this purpose, the connection of all hook-and-loop tapes 17 used in the back region 5 is first loosened. Disassembly of the expanders 10 is not necessary, but may be provided alternatively for easier handling. In the next step, the spacer elements 18a, 18b are attached between the upper body part 6 and the torso 2. The height of the spacer elements H corresponds to the maximum stroke h to be set. For precise adjustment, it is advisable to use four spacer elements 18a, 18b, one on the left and one on the right in the abdominal region 4 and in the chest region 3, respectively. Once all spacer elements 18a, 18b have been installed, the hook-and-loop tapes in the back region 5 are fixed to each other at their ends, in the manner of a hook-and-loop fastener. If a different maximum stroke h is to be set for the chest region 3 and the abdominal region 4, spacer elements 18a, 18b with different heights H may be used. Then, it may be convenient to adjust the range of the larger maximum stroke h first, and when the corresponding hook-and-loop tape is fixed, proceed by adjusting the range of the smaller maximum stroke h.

### LIST OF REFERENCE SIGNS

1 dummy object
2 torso
3 chest region
4 abdominal region
5 back region
6 upper body part
7 actuator
7a balloon
7b turntable
8 basic position of the upper body part
9 deflected position of upper body part
10 elastic reset element/expander
11 first recess in torso
12 second recess in torso
13 leg
14 cavity
15 through-hole
16 compressed air hose
17 stroke limiting element/hook-and-loop tape
18a first spacer element
18b second spacer element
19 arm
20 head
21 motor axis or axis of rotation
h maximum stroke of the upper body part
H height of spacer element

1. A dummy object for functional testing of child presence detection systems (CPD system), comprising a torso having a chest region, an abdominal region and a back region, further comprising an upper body part movable relative to the torso for imitating a respiratory movement, the upper body part forming at least part of a chest/abdomen contour of the dummy object to be detected by the CPD system, and comprising an actuator arranged to deflect the upper body part from a basic position into a deflected position, wherein the dummy object has at least one elastic reset element arranged to return the upper body part from the deflected position into the basic position.

2. The dummy object according to claim 1, wherein the elastic reset element is an expander, the expander being fixed in a first recess in the back region of the torso and being guided by means of a second recess in the torso and/or in the upper body part, wherein the dummy object comprises at least two expanders

3. The dummy object according to claim 1, wherein the dummy object comprises two legs and the torso has a cavity, wherein the cavity is at least partially enclosed by the upper body part and wherein the torso has a through-hole that is arranged between the two legs and forms an access to the cavity, wherein the actuator is arranged in the cavity and is coupled to a supply system through the through-hole.

4. The dummy object according to claim 1, wherein the actuator comprises at least one inflatable balloon, wherein the at least one inflatable balloon is connected to the supply system via a compressed air hose, wherein the supply system is a pneumatic system and wherein the inflatable balloon is configured to increase its volume by supplying compressed air and to decrease the volume again by releasing the compressed air.

5. The dummy object according to claim 4, wherein the pneumatic system comprises a valve unit and a control unit, which are configured to supply air to and release air from the at least one inflatable balloon in a controlled manner.

6. The dummy object according to claim 5, wherein the pneumatic system is configured such that, by means of the controlled air supply and the accompanying deflection of the upper body part from the basic position into the deflected position, the movement of the human chest and abdominal region during inhalation is simulated.

7. The dummy object according to claim 5, wherein the pneumatic system is configured such that by means of the controlled release of air in connection with the resetting element the upper body part is returned from the deflected position into the basic position and the movement of the human chest and abdominal region during exhalation is simulated.

8. The dummy object according to claim 5, wherein the valve unit is controlled by means of pulse width modulation, wherein a respiratory rate is set via a duration of the air supply and the air release and a respiratory frequency is set via a frequency of the air supply and the air release.

9. The dummy object according to claim 1, wherein the upper body part comprises at least one stroke limiting element that is configured to limit the movement of the upper body part relative to the torso to a maximum stroke.

10. The dummy object according to claim 9, wherein the upper body part comprises at least two stroke limiting elements, wherein a stroke of the upper body part at the abdominal region is allowed to differ from a stroke of the upper body part at the chest region.

11. The dummy object according to claim 9, wherein the at least one stroke limiting element is a hook-and-loop tape, wherein the hook-and-loop tape is configured to be manually fixed and calibrated.

12. The dummy object according to claim 1, wherein the upper body part is made in two parts and the parts of the upper body part are movable independently of each other.

13. The dummy object according to claim 4, wherein the inflatable balloon is associated with a pressure silencer, a compressed air filter and a mechanical pressure limiter, wherein the pressure in the balloon is continuously monitored, and wherein the pressure in the balloon should not exceed 2 bar.

14. The dummy object according to claim 1, wherein the actuator comprises at least one rotationally driven eccentric, by means of which the upper body part is deflectable from the basic position into the deflected position.

15. The dummy object comprising a torso and an upper body part that is movable relative to the torso for imitating a respiratory movement, the upper body part forming at least part of a chest/abdomen contour of the dummy object to be detected by the CPD system, further comprising an actuator configured to deflect the upper body part from a basic position into a deflected position, according to claim 1, wherein the actuator comprises an electric motor, the actuator being configured to return the upper body part from a deflected position into the basic position.

16. A method for setting the maximum stroke of a breathing movement of a dummy object according to claim 9, wherein at least one spacer element is used to set up the stroke limiting element, the size of the spacer element corresponding in at least one spatial dimension to the stroke to be set, wherein the stroke limiting element is initially not fixed so as to enable the spacer element to be fitted between the torso and the upper body part, wherein subsequently the stroke limiting element is fixed so as to set the maximum stroke of the breathing movement after removal of the at least one spacer element.

17. The dummy object according to claim 2, wherein the dummy object comprises at least four expanders.

18. The dummy object according to claim 4, wherein the actuator comprises at least two inflatable balloons.

19. The dummy object according to claim 10, wherein the at least two stroke limiting elements comprise at least a first stroke limiting element being attached to the abdominal region of the torso and at least a second stroke limiting element being attached to the chest region of the torso.

20. The dummy object according to claim 15, wherein the electric motor is configured as a servomotor.
